(19) United States
(12) Patent Application Publication
(10) Pub. No.: US 2010/0312372 A1
(43) Pub. Date: Dec. 9, 2010

(54) SYSTEM AND METHOD FOR PLANNING GLOBAL LOGISTICS IN TFT-LCD MANUFACTURING INDUSTRY

(75) Inventors: Kung-Jeng Wang, Taipei County (TW); Shih-Min Wang, Taipei County (TW); Chou-Jeng Chen, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei (TW)

(21) Appl. No.: 12/564,922

(22) Filed: Sep. 23, 2009

(30) Foreign Application Priority Data
Jun. 3, 2009 (TW) 98118430

(51) Int. Cl. G06F 19/00

(52) U.S. Cl. 700/102; 700/109; 700/105

(57) ABSTRACT

A system and a method of planning global logistics for a TFT-LCD manufacturing industry are provided. The system includes an input module and an industry characteristic planning module with a front-end process transformation module and a back-end transportation allocation module. The input module is used for selecting a performance index and inputting related parameters such as manufacturing parameters and shipping parameters. The front-end process transformation module calculates the number of each semi-finished product at each of the front-end TFT-LCD manufacturing factories so as to estimate an glass substrate input quantity for each respective front-end TFT-LCD manufacturing factory. The back-end transportation allocation module calculates a shipping quantity of the semi-finished products shipped from each front-end TFT-LCD manufacturing factory to each back-end LCM factory, and calculates the number of semi-finished products received from each front-end TFT-LCD manufacturing factory in each back-end LCM factory.

### CROSS-REFERENCE TO RELATED APPLICATION

This application claims the priority benefit of Taiwan application serial no. 98118430, filed Jun. 3, 2009. The entirety of the above-mentioned patent application is hereby incorporated by reference herein and made a part of this specification.

### BACKGROUND OF THE INVENTION

1. Field of the Invention

The present invention generally relates to a capacity allocation method, and more particularly to a system and method of planning global logistics for a TFT-LCD manufacturing industry.

2. Description of Related Art

With more users replacing their CRT displays, the TFT-LCD has gradually become the mainstream display.

Being aware of multiple competitors investing in next generational capacities and the labor costs involved, TFT-LCD panel manufacturers usually perform front-end manufacturing at the technology-intensive place. On the other hand, LCD Module (LCM) assembly is performed at the place of demand. Practically, experience dominates the capacity allocation strategy for specifying the appropriate products to produce at a specific manufacturing location. Therefore, the aforementioned techniques affect the performance of the enterprises.

Accordingly, with effective management of global logistics and resource allocation, integrated competitive advantages can be gained by saving a maximal amount of costs and wastes.

### SUMMARY OF THE INVENTION

The present invention is directed to a method and a system for planning a global logistics system of a TFT-LCD manufacturing industry, thereby obtain a global logistical and capacity allocation plan.

The present invention provides a global logistics system for a TFT-LCD manufacturing industry suitable for globally allocating among multiple front-end TFT-LCD manufacturing factories and multiple back-end LCM factories. The front-end TFT-LCD manufacturing factories generate multiple semi-finished products. The back-end LCM factories receive these semi-finished products for module assembly. The global logistics system includes an input module and an industry characteristic planning module that has a front-end process transformation module and a back-end transportation allocation module. The input module is used for selecting a performance index and for entering the related parameters. The industry characteristic planning module is used for receiving the performance index and the related parameters. Herein, the front-end process transformation module calculates each semi-finished product quantity at each of the front-end TFT-LCD manufacturing factories. The calculation is performed according to the manufacturing parameters in order to estimate a glass substrate input quantity for each of the front-end TFT-LCD manufacturing factories. The back-end transportation allocation module calculates a shipping quantity. The shipping quantity of each semi-finished product is transported from each front-end TFT-LCD manufacturing factory to each back-end LCM factory. The back-end transportation allocation module calculates the total input quantity of semi-finished products received by each of the back-end LCM factories from each of the front-end TFT-LCD factories.

In one embodiment of the present invention, the aforementioned front-end process transformation module includes a capacity equivalent transformation module, an economical cutting rate transformation module, a cutting area loss transformation module, a manufacturing feasibility evaluation module, a demand limitation module, and a front-end resource limitation module. The capacity equivalent transformation module references a resource consumption quantity for manufacturing standard product in order to convert the resource consumption quantity into a capacity equivalent. The economical cutting rate transformation module calculates a glass substrate input quantity according to the semi-finished product cutting rate. The cutting area loss transformation module calculates a glass substrate loss area. The manufacturing feasibility evaluation module is used for determining whether the semi-finished products can be produced in each of the front-end TFT-LCD manufacturing factories. The demand limitation module limits the semi-finished product quantity. The front-end resource limitation module limits the semi-finished product quantity.

In one embodiment of the present invention, the aforementioned back-end transportation allocation module includes a shipping quantity distribution module, an input quantity calculation module, an inventory transformation module, an inventory limitation module, and a back-end resource limitation module. Herein, the shipping quantity distribution module calculates the shipping quantity of each semi-finished product from each of the front-end TFT-LCD manufacturing factories to each of the back-end LCM factories. The input quantity calculation module calculates a total input quantity of the semi-finished products for each of the back-end LCM factories. The semi-finished product inventory transformation module calculates the inventory quantity of each semi-finished product. The inventory limitation module limits the inventory quantity according to a storage space. The back-end resource limitation module limits a product quantity according to the available capacity.

In one embodiment of the present invention, the performance index is to minimize a total cost, to minimize a glass substrate loss area, and to maximize a production quantity, or a combination thereof.

In another perspective, the present invention provides a method for planning global logistics of a TFT-LCD manufacturing industry that is suitable for multiple front-end TFT-LCD manufacturing factories and multiple back-end LCM factories, where the front-end TFT-LCD manufacturing factories produce multiple semi-finished products, and where the back-end LCM factories receive the semi-finished products for module assembly. In the method of the present invention, a performance index and a plurality of related parameters are entered. The related parameters include manufacturing parameters and shipping parameters. Thereafter, each semi-finished product quantity at each of the front-end TFT-LCD manufacturing factories is calculated. Thereafter, respective calculations of a shipping quantity of each semi-finished product to transport from each of the front-end TFT-LCD manufacturing factories to each of the back-end LCM factories are performed. Thereafter, the total input quantity of the semi-finished products is calculated.

In one embodiment of the present invention, the aforementioned process of the semi-finished product quantity calculation includes calculating the capacity equivalent. Furthermore, whether each semi-finished product is producible at each front-end TFT-LCD manufacturing factory is determined. A cutting area loss transformation module calculates a glass substrate loss area for the semi-finished products.

After the aforementioned process of calculating the shipping quantity of each semi-finished product, an inventory quantity at each of the front-end TFT-LCD manufacturing factories is calculated.

In one embodiment of the invention, the aforementioned inventory calculation process can be limited according to a storage space at each of the front-end TFT-LCD manufacturing factories.

In one embodiment of the invention, the method for planning global logistics includes limiting the production quantity of each product according to the available capacity.

In summary, embodiments of the present invention may generate a production plan for the front-end TFT-LCD manufacturing factories, a resource allocation plan for the back-end LCM factories, and a shipping plan for transportation between the front-end and back-end factories. Accordingly, production costs are substantially lowered due to more efficient global logistics planning.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a global logistics environment in accordance with one embodiment of the present invention.

FIG. 2 is a block diagram of a global logistics system in accordance with one embodiment of the invention.

FIG. 3 is a structural schematic diagram of the global logistics system in accordance with one embodiment of the invention.

FIG. 4 is a flow chart of the method for planning global logistics in accordance with one embodiment of the present invention.

FIG. 5A to FIG. 5K are schematic views showing input and output data in accordance with the method for planning global logistics in one embodiment of the present invention.

### DESCRIPTION OF EMBODIMENTS

Practically, production planning for the TFT-LCD manufacturing industry is usually performed by spreadsheet software while capacity allocation is determined by experience. The aforementioned technique results in performance limitations in businesses. In light of the foregoing, in order to more effectively reduce production costs, the present invention provides a system and a method of planning global logistics of a TFT-LCD manufacturing industry. In order to facilitate the descriptions, the embodiments below use the TFT-LCD manufacturing industry as an example.

FIG. 1 is a schematic view of a global logistics environment in accordance with one embodiment of the present invention. Referring to FIG. 1, an enterprise has determined a production quantity from analyzing customer orders and historical data. Input data is represented by various sized product quantities of each period. A production need is allocated to each of front-end TFT-LCD manufacturing factories.

The work environment of the TFT-LCD manufacturing industry can be partitioned into two stages: a first stage involves setting a glass substrate input quantity and a resource allocation for each of the front-end TFT-LCD manufacturing factories 1˜n; a second stage involves capacity logistics planning, which requires determining an optimal logistics allocation plan and thereafter, using the allocation plan to transport semi-finished products to the back-end LCM factories 1˜m for module assembly.

The first stage includes the following industry characteristics. A capacity calculation is based on a capacity for producing a standard product, as well as a capacity equivalent for producing other products. When producing a panel, capacity utilization takes into account an economical cutting rate. Moreover, various degrees of glass substrate loss can occur since different front-end TFT-LCD manufacturing factories utilize different economical cutting rates.

In addition, the second stage includes the following characteristics. The semi-finished products are produced by the array and cell processes, and they are stored as panels at the front-end TFT-LCD manufacturing factories awaiting transport to the back-end LCM factories for module assembly. A shipping quantity between the TFT-LCD manufacturing factories and LCM factories is determined.

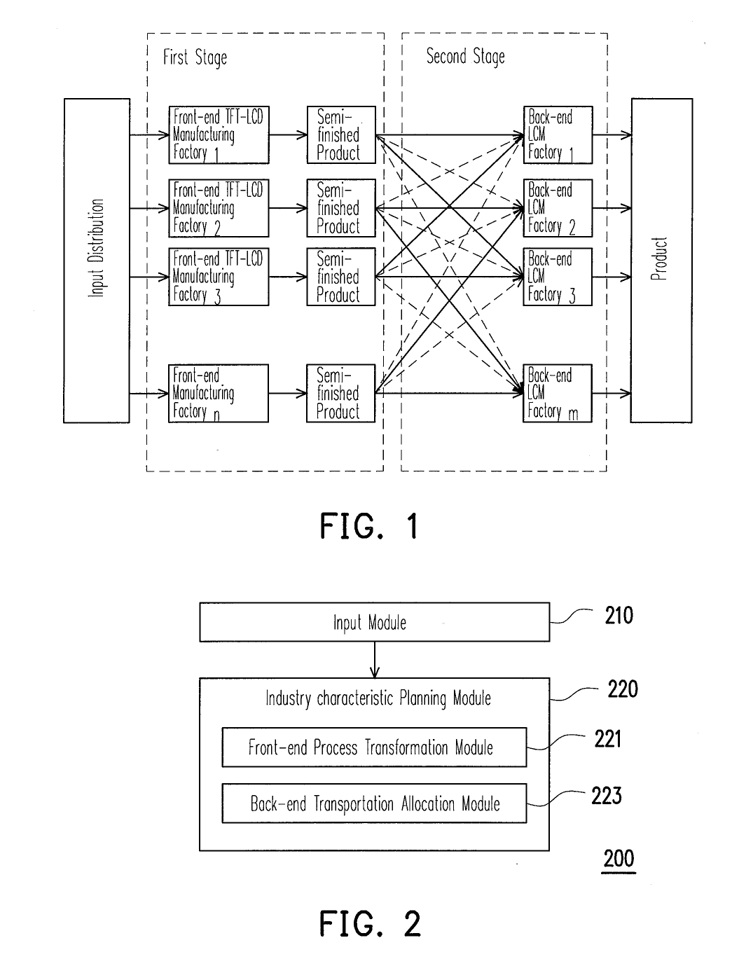

FIG. 2 is a block diagram of the global logistics system. Referring to FIG. 2, the global logistics system 200 includes an input module 210 and an industry characteristic planning module 220. The industry characteristic planning module 220 includes a front-end process transformation module 221 and a back-end transportation allocation module 223. The following are descriptions of each of the modules.

The input module 210 is used to define the performance index and input the related parameters, so as to fit the industry characteristic planning module 220 more closely to the current enterprise environment. Herein, the related parameters include manufacturing parameters and shipping parameters.

The manufacturing parameters include a market demand, a manufacturing feasibility, a yield, a capacity, an economical cutting rate, a glass substrate cutting loss rate, an capacity equivalent, and a glass substrate cost. The shipping parameters include a shipping feasibility, a shipping limit, a back-end assembly feasibility, and a shipping cost.

In addition to the manufacturing parameters and the shipping parameters, the related parameters further includes a front-end TFT-LCD manufacturing factory generation number, economical cutting rate, and glass substrate cutting loss rate. In addition, a planning period index is included for determining the long-term capacity allocation. A factory index is included for determining each front-end TFT-LCD manufacturing factories and the back-end LCM factories. A product type index is applied for determining the number of product types to allocate.

In the present embodiment of the invention, three performance indices are provided. The performance index is to minimize a total cost, to minimize a glass substrate loss area, and to maximize a production quantity, or a combination thereof. Specifically, the minimized total cost means that during the planning period, the target is for a sum of the glass substrate cost, the inventory cost (e.g. storage cost), and the shipping cost to be minimized. The minimized glass substrate cutting loss area means that during the planning period, the target is for a sum of the glass substrate area wastage during the cutting glass substrate to be minimized. The maximized production quantity means that the target is for a total number of finished products from the back-end LCM factories to be maximized.

In addition, the industry characteristic planning module 220 is adapted for receiving the performance index and the related parameters. Herein, the front-end process transformation module 221 calculates the semi-finished product quantity for estimating the glass substrate input quantity. The calculation references the performance index and is performed according to the manufacturing parameters. The back-end transportation allocation module 223 respectively calculates a shipping quantity of each semi-finished product to transport from each of the front-end TFT-LCD manufacturing factories to each of the back-end LCM factories. The back-end transportation allocation module 223 calculates the semi-finished product quantity received by each of the back-end LCM factories from each of the front-end TFT-LCD manufacturing factories.

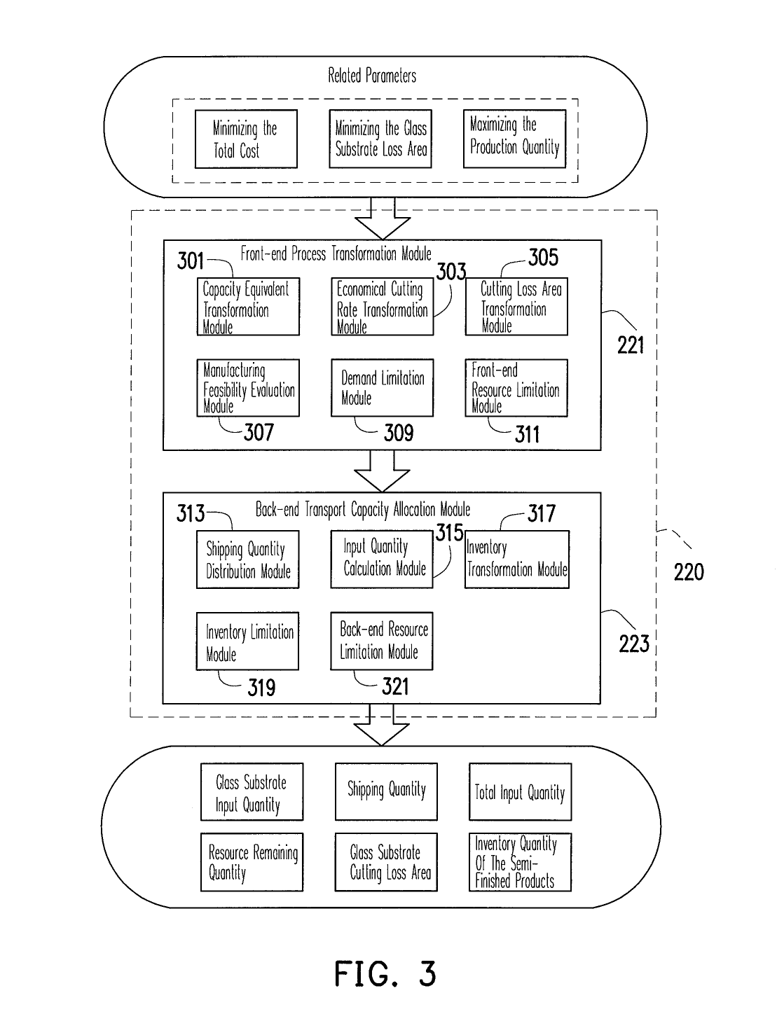

Another embodiment of the present invention is detailed below to describe the front-end process transformation module 221 and the back-end transportation allocation module 223. FIG. 3 is a structural schematic diagram of the global logistics system. Referring to FIG. 3, the front-end process transformation module 221 includes a capacity equivalent transformation module 301, an economical cutting rate transformation module 303, a cutting loss area transformation module 305, a manufacturing feasibility evaluation module 307, a demand limitation module 309, and a front-end resource limitation module 311. The back-end transportation allocation module 223 includes a shipping quantity distribution module 313, an input quantity calculation module 315, an inventory transformation module 317, an inventory limitation module 319, and a back-end resource limitation module 321.

In the front-end process transformation module 221, the capacity equivalent transformation module 301 references a resource consumption quantity for producing a standard product in order to convert the resources consumed for manufacturing products relate to the standard product. In calculating resource needs, the capacity equivalent is used to determine resource limitations during production. The capacity equivalent changes according to characteristics such as product size and different generation manufacturing factories. An equation can be used to describe the capacity equivalent transformation module 301. The equation is as follows:

$${\sum }_{j} ( {a}_{i , j} \times {Y}_{p , i , j} \times {k}_{i , j} ) \leq {e}_{p , i} ∀ p , i , j .$$

In the equation, an actual capacity can be determined by multiplying a feasibility factor a_{i,j} with a panel quantity at p period and with a capacity equivalent k_{i,j} of the product j at the factory i. And the total usage of the capacity should be less than or equal to available capacity e_{p,i}.

The economical cutting rate transformation module 303 calculates the glass substrate input quantity according to the semi-finished product quantity. Since different generation manufacturing factories use specific size of panel, producing products of different sizes results in a different economical cutting rate. Accordingly, during resource allocation for the TFT-LCD manufacturing industry, utilizing rates are considered for their economical benefit. During production, conversion between the glass substrate input quantity and the semi-finished product quantity is performed by considering the glass substrate area, the product size, and the product quantity at each generation factory. The conversion can be described as:

$${Y}_{p , i , j} = \frac{{X}_{p , i , j} \times {cn}_{i , j}}{y {d}_{p , i}} ∀ p , i , j .$$

A panel quantity Y_{p,i,j} of the product is equal to a glass substrate input quantity X_{p,i,j} multiplied by the product's economical cutting rate cn_{i,j}, and further divided by yield yd_{p,i}.

A cutting loss area transformation module 305 calculates a glass substrate loss area according to a glass substrate cutting loss rate. Therefore, by analyzing the glass substrate cutting loss rate using the cutting loss area transformation module 305 while also taking into account characteristics of different product sizes, the glass substrate wastage can be reduced. For instance:

A_{p,i,j}=X_{p,i,j}×f_{i,j}×gᵢ∀_{p,i,j}.

Glass substrate loss area A_{p,i,j} is obtained by multiplying the glass substrate input quantity X_{p,i,j} by a product cutting loss area percentage f_{i,j} and by a glass substrate area gᵢ.

A manufacturing feasibility evaluation module 307 is used for determining whether the semi-finished products can be produced. The determination is made by using a manufacturing feasibility parameter. In general, not all front-end TFT-LCD manufacturing factories have the capability to produce products of all sizes under the consideration of production technology.

A demand limitation module 309 limits the production quantity according to the market demand. For instance:

$${\sum }_{k} {D}_{p , j , k} \geq {d}_{p , j} ∀ p , j .$$

D_{p,j,k} is a finished production quantity that is necessary to satisfy a demand quantity d_{p,j}.

The front-end resource limitation module 311 limits the semi-finished production quantity according to available capacity. For instance:

$${\sum }_{j} ( {a}_{i , j} \times {Y}_{p , i , j} \times {k}_{i , j} ) \leq {e}_{p , i} ∀ i , p , j .$$

In each planning period, the capacity used by each front-end TFT-LCD manufacturing factory should be less than or equal to e_{p,i}, a capacity limiting quantity.

Furthermore, in the back-end transportation allocation module 223, the shipping quantity distribution module 313 respectively calculates a shipping quantity from each of the front-end TFT-LCD manufacturing factories to each of the back-end LCM factories. The shipping quantity distribution module 313 particularly emphasizes on parameters such as shipping feasibility, shipping quantity limitation, and back-end assembly feasibility in order to generate a workable shipping plan. For instance:

$${D}_{p , j , k} = {\sum }_{i} ( {ra}_{i , k} \times {la}_{j , k} \times {R}_{p , j , i , k} \times y {d}_{p , j} ) ∀ p , j , k .$$

The shipping quantity is distributed across each type of products in each time period according to a shipping feasibility ra_{i,k} and the back-end assembly feasibility la_{i,k}.

$${\sum }_{j} ( {ra}_{i , k} \times {R}_{p , i , j , k} ) \leq {q}_{p , i , k} ∀ p , i , k .$$

In addition, the shipping quantity R_{p,j,i,k} must be smaller or equal to the shipping quantity limitation q_{p,i,k}.

The input quantity calculation module 315 calculates a total input quantity of the semi-finished products for the back-end LCM factories. For instance:

$${H}_{p , i , j} = {H}_{p - 1 , i , j} + {X}_{p , i , j} \times {cn}_{i , j} - {\sum }_{j} ( {ra}_{i , k} \times {R}_{p , i , j , k} ) ∀ i , j , p .$$

An inventory quantity H_{p,i,j} is calculated by adding an inventory quantity H_{p-1,i,j} of the previous planning period to the panel quantity of the current planning period, and thereafter subtracting a shipping quantity transported to the back-end factory.

The inventory transformation module 317 calculates the inventory quantity of each respective semi-finished product according to the semi-finished product quantity and the shipping quantity. For instance:

$${H}_{p , i , j} = {H}_{p - 1 , i , j} + {Y}_{p , i , j} - {\sum }_{k} ( {ra}_{i , k} \times {R}_{p , j , i , k} ) ∀ i , j , p .$$

Herein, a semi-finished panel inventory quantity H_{p,i,j} of the current planning period is equal to the semi-finished panel inventory quantity H_{p-1,i,j} of the previous planning period, adding the semi-finished panel quantity Y_{p,i,j} of the current planning period, and subtracting the semi-finished panel quantity shipped to the back-end LCM factories.

The inventory limitation module 319 limits the inventory quantity according to the storage quantity such as warehouse size and enterprise strategies. For instance:

$${\sum }_{j} {H}_{p , i , j} \leq {Hq}_{p , i} ∀ p , i = 0.$$

The inventory quantity Hq_{p,i} must be less than or equal to the storable inventory quantity Hq_{p,i} of the storage facilities.

The back-end resource limitation module 321 limits the semi-finished product quantity according to the available capacity. For instance:

$${\sum }_{i} {\sum }_{j} ( {ra}_{i , k} \times {la}_{j , k} \times {R}_{p , i , j , k} ) \leq {e}_{p , k}^{M} ∀ k , p .$$

In each planning period, the capacity used by each back-end TFT-LCD manufacturing factory should be less than or equal to a capacity limitation quantity.

After inputting the related parameters and the performance index into the industry characteristic planning module 220, primary results received by the front-end process transformation module 221 and the back-end transportation allocation module 223. The primary results include the glass substrate input quantity, the shipping quantity to transport from the front-end TFT-LCD manufacturing factories to the back-end LCM factories, and the total input quantity of semi-finished products received by the back-end LCM factories. In other words, the resource allocation plan for the front-end TFT-LCD manufacturing factories is determined. Furthermore, the resource allocation plan for the back-end LCM factories is determined. In addition, the global logistics plan is determined by the shipping quantity.

Besides the aforementioned primary results, some secondary results are gathered from calculations performed by the module 221 and module 223. These secondary results include a resource remaining quantity, a glass substrate cutting loss area, and an inventory quantity. More specifically, the resource remaining quantity is calculated by using the economical cutting rate transformation module 303, and thereafter using the capacity equivalent transformation module 301 to convert the semi-finished product quantity to the resource remaining quantity. Accordingly, the resource remaining quantity represents a capacity that is available to receive more orders or bypass other orders. The glass substrate loss area for the front-end TFT-LCD manufacturing factories is determined by the cutting loss area transformation module 305. Furthermore, the inventory quantity of semi-finished products at the front-end TFT-LCD manufacturing factories is determined by the economical cutting rate transformation module 303.

In order to further describe the method of planning the aforementioned global logistics system, another embodiment is described below.

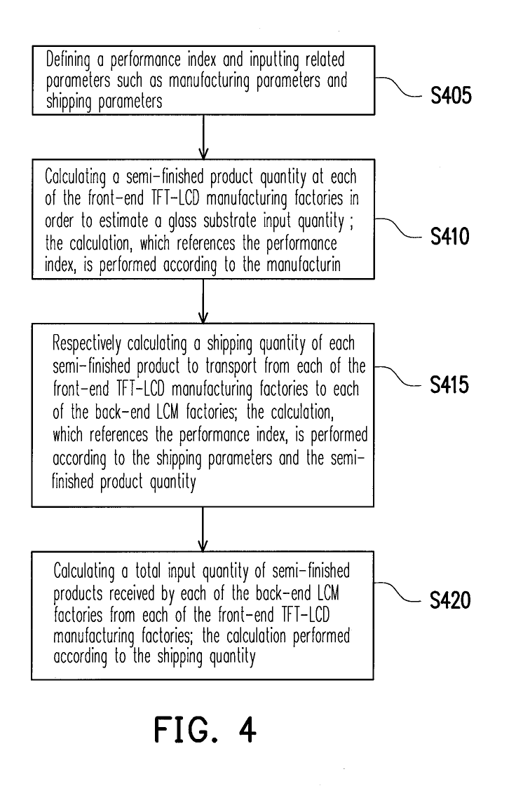

FIG. 4 is a flow chart of the method for planning global logistics. Referring to FIG. 4, as depicted in Step S405, the performance index is defined, and a plurality of related parameters is inputted. Thereafter, in Step S410, the semi-finished product quantity is calculated. While calculating the semi-finished product quantity, the capacity equivalent is calculated. The calculation, which references a resource consumption quantity of a standard product, converts the resource quantity into the capacity equivalent. Furthermore, whether each semi-finished product is producible is determined by the manufacturing feasibility parameter. In addition, the glass substrate cutting loss area of each of the front-end TFT-LCD manufacturing factories is calculated by taking into account the glass substrate cutting loss rate.

Thereafter in Step S415, calculation of the shipping quantity for transport from each of the front-end TFT-LCD manufacturing factories to each of the back-end LCM factories is performed respectively. In addition, calculation of the inventory quantity of the semi-finished product at each of the front-end TFT-LCD manufacturing factories is performed. The inventory quantity is limited by the storage quantity at each of the front-end TFT-LCD manufacturing factories.

Thereafter, as shown in Step S420, the total input quantity is calculated according to the semi-finished product quantity received by each of the back-end LCM factories from each of the front-end TFT-LCD manufacturing factories.

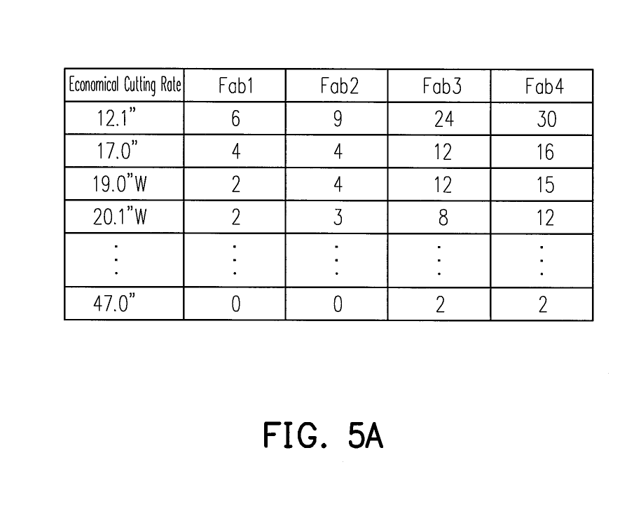

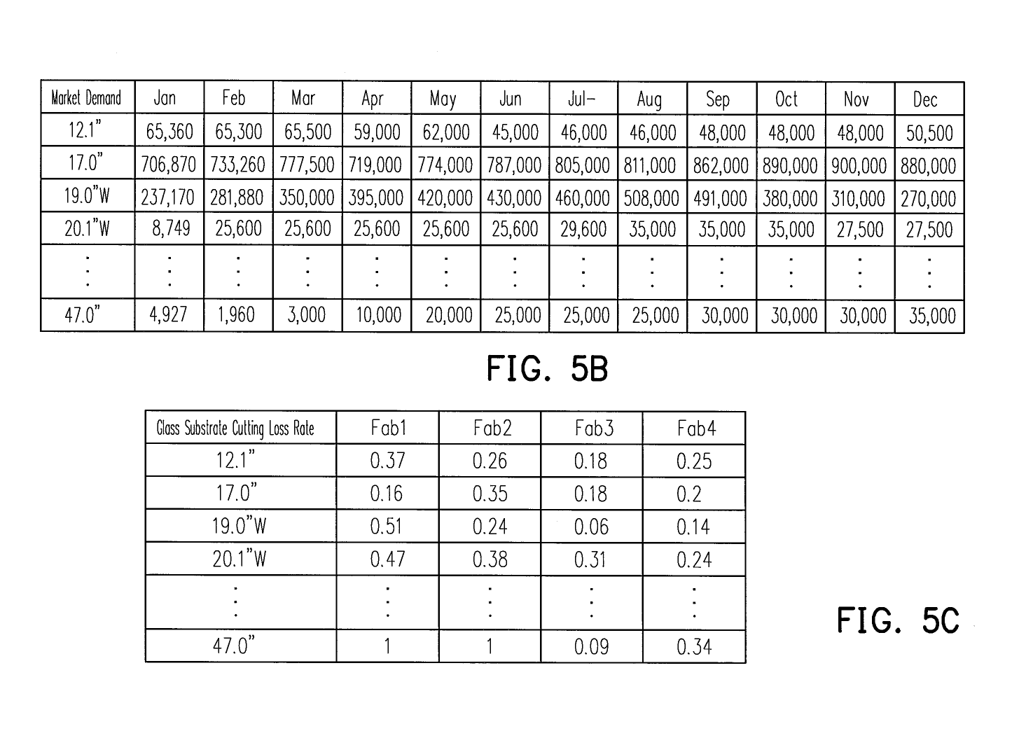

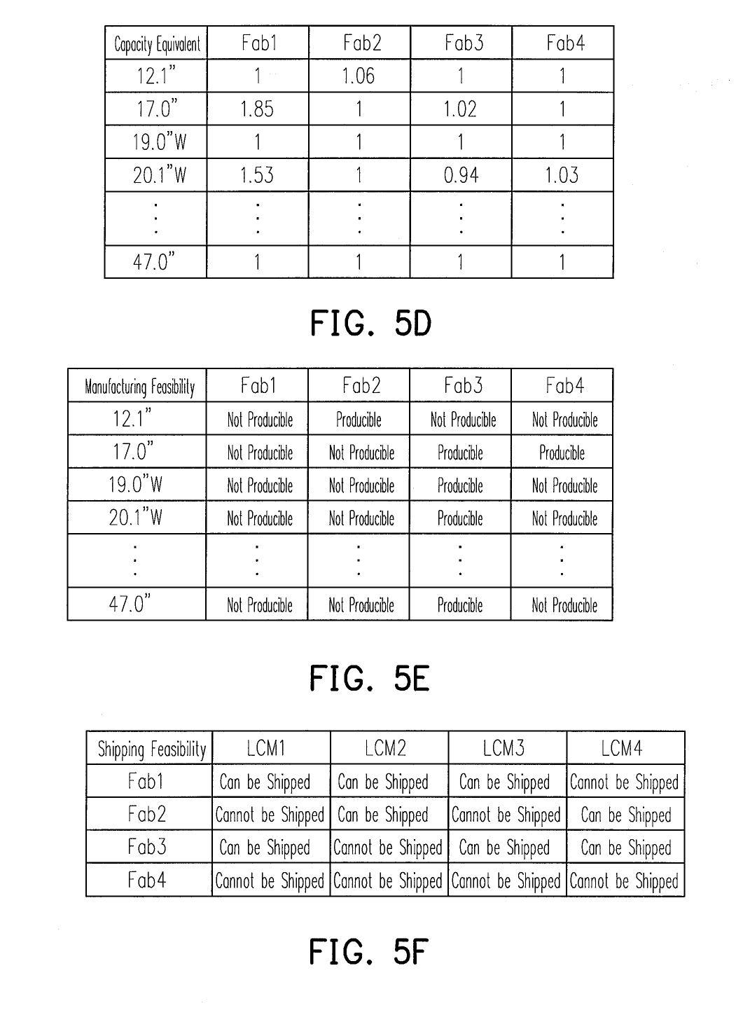

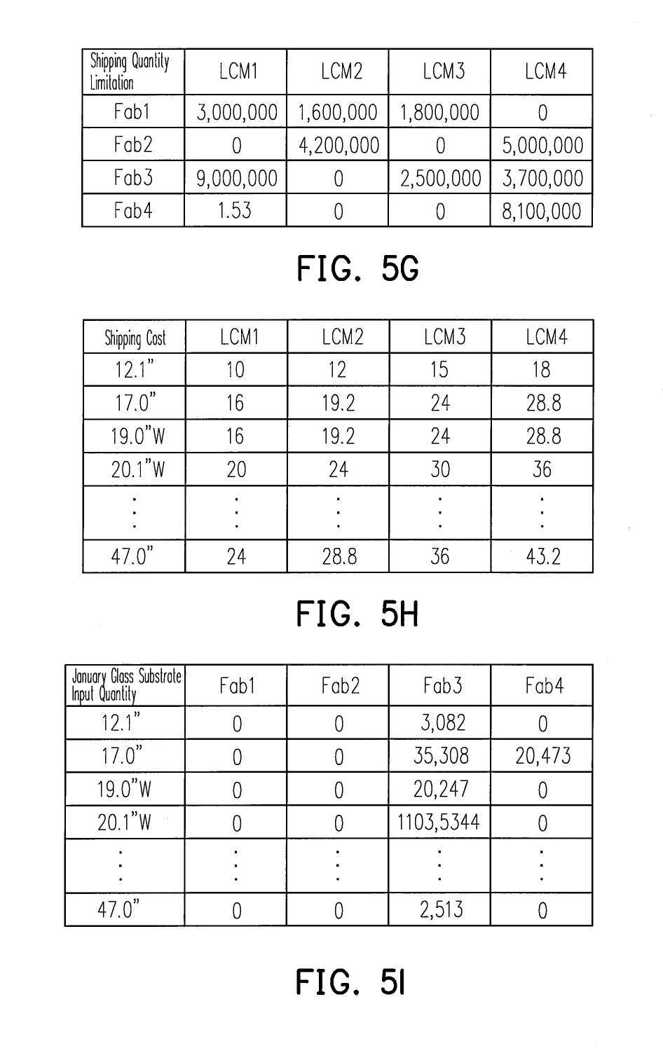

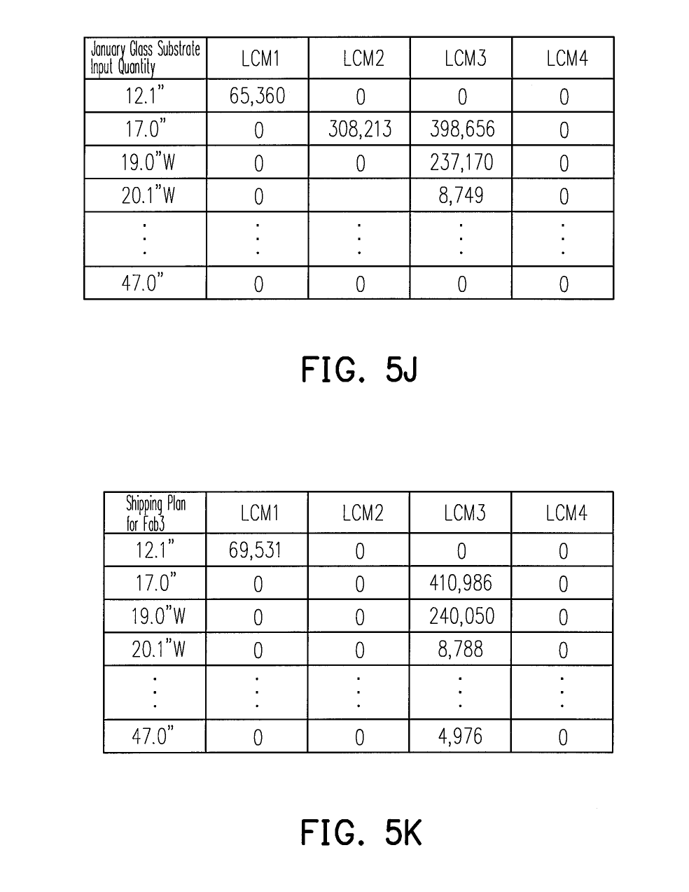

FIG. 5A to FIG. 5K are schematic views showing a plurality of input and output data. The basic settings for the present embodiment are as follows: a unit of the planning period is a month (12 planning periods); 4 front-end TFT-LCD manufacturing factories (Fab1-Fab4); 4 back-end LCM factories (LCM1-LCM4); there are 47 products each needing a glass substrate input quantity for each month. Herein, FIG. 5A to FIG. 5H represent input data, while FIG. 5I to FIG. 5K represent output data. When the related parameters shown in FIG. 5A to FIG. 5H are entered into the module 220, calculation by the module 221 and the module 223 arrive at the results shown in FIG. 5I to FIG. 5K.

FIG. 5A, FIG. 5C, FIG. 5D, and FIG. 5E respectively show the economical cutting rate, the glass substrate cutting loss rate, the capacity equivalent, and the manufacturing feasibility of the front-end TFT-LCD manufacturing factories Fab1-Fab4. FIG. 5B shows the market demand. FIG. 5F, FIG. 5G, and FIG. 5H show the shipping parameters. FIG. 5F and FIG. 5G respectively show the shipping feasibility and the shipping quantity limitation for transport between the back-end LCM factories LCM1-LCM4 and the front-end TFT-LCD manufacturing factories Fab1-Fab4. FIG. 5H shows the shipping cost of each product for the back-end factories LCM1-LCM4.

On the other hand, FIG. 5I and FIG. 5J use January as example, while FIG. 5K uses the front-end TFT-LCD manufacturing factory Fab3 as an example. FIG. 5I shows the allocation plan for each product's glass substrate input quantity at each of the front-end TFT-LCD manufacturing factories Fab1-Fab4. FIG. 5J shows each product's total input quantity of semi-finished products after January at the back-end LCM factories LCM-LCM4. FIG. 5K shows the shipping quantity of each product that is transported from the front-end TFT-LCD manufacturing factory Fab3 to the back-end LCM factories LCM1-LCM4.

Accordingly, the glass substrate input quantity is obtained through the front-end process transformation module. Therefore, embodiments of the present invention may help end-users generate a long term resource allocation plan. Moreover, a shipping plan between the front-end and back-end factories is provided. Therefore, the efficiency of resource allocation is increased, and end-users are benefit by the integrated competitive advantages.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A global logistics system for a TFT-LCD manufacturing industry of multiple front-end TFT-LCD manufacturing factories and multiple back-end LCM factories, the front-end TFT-LCD manufacturing factories generating multiple semi-finished products of multiple products, the back-end LCM factories receiving the semi-finished products for module assembly, and the global logistics system comprising:
an input module for defining a performance index and inputting a plurality of related parameters; and
an industry characteristic planning module for receiving the performance index and the related parameters, the industry characteristic planning module comprising:
a front-end process transformation module for calculating a semi-finished product quantity of each respective semi-finished product at each of the front-end TFT-LCD manufacturing factories, and the calculation is used to estimate a glass substrate input quantity; and
a back-end transportation allocation module for respective calculations of a shipping quantity of each semi-finished product to transport from each of the front-end TFT-LCD manufacturing factories to each of the back-end LCM factories, and the shipping quantity is used to further calculate a total input quantity of the semi-finished products at each of the back-end LCM factories, wherein each of the back-end LCM factories received the semi-finished products from each of the front-end TFT-LCD manufacturing factories.

2. The global logistics system as claimed in claim 1, wherein the front-end process transformation module comprises:
a capacity equivalent transformation module for calculating a capacity equivalent, wherein the calculation references a resource consumption quantity of a standard product in order to convert resources consumed to manufacturing other products into the capacity equivalent;
an economical cutting loss rate transformation module for calculating the glass substrate input quantity according to the respective semi-finished product quantity of the products;
a cutting loss area transformation module for calculating a glass substrate loss area, wherein the calculation is performed according to a glass substrate cutting loss rate; and
a manufacturing feasibility evaluation module for determining whether each respective semi-finished product is produced, wherein the determination is made according to a manufacturing feasibility parameter.

3. The global logistics system as claimed in claim 2, wherein the front-end process transformation module further comprises:
a demand limitation module for limiting the semi-finished product quantity at a demand quantity; and
a front-end resource limitation module for limiting the semi-finished product quantity according to available capacity.

4. The global logistics system as claimed in claim 1, wherein the back-end transportation allocation module comprises:
a shipping quantity distribution module for respective calculations of the shipping quantity of each respective semi-finished product to transport from each of the front-end TFT-LCD manufacturing factories to each of the back-end LCM factories; and
an input quantity calculation module for calculating the total input quantity of semi-finished products at each of the back-end LCM factories.

5. The global logistics system as claimed in claim 4, wherein the back-end transportation allocation module further comprises:
an inventory transformation module for calculating an inventory quantity at each of the front-end TFT-LCD manufacturing factories according to the semi-finished product quantity and the shipping quantity;
an inventory limitation module for limiting the inventory quantity according to a inventory quantity; and
a back-end resource limitation module for limiting a production quantity according to available capacity.

6. The global logistics system as claimed in claim 1, wherein the performance index is to minimize a total cost, or minimize a glass substrate cutting loss area, or maximize a production quantity, or a combination thereof.

7. A method for planning global logistics for a TFT-LCD panel industry of multiple front-end TFT-LCD manufacturing factories and multiple LCM factories, the front-end TFT-LCD manufacturing factories generating multiple semi-finished products of multiple products, the back-end LCM factories receiving the semi-finished products for module assembly, and the method for planning global logistics comprises:
defining a performance index and inputting a plurality of related parameters; and
calculating a semi-finished product quantity of each respective semi-finished product at each of the front-end TFT-LCD manufacturing factories, and the calculation is used to estimate an glass substrate input quantity; and
respectively calculating a shipping quantity of each semi-finished product to transport from each of the front-end TFT-LCD manufacturing factories to each of the back-end LCM factories; and
calculating a total input quantity of the semi-finished products at each of the back-end LCM factories that received the semi-finished products from each of the front-end TFT-LCD manufacturing factories, wherein the calculation is performed according to the shipping quantity.

8. The method for planning global logistics as claimed in claim 7, wherein calculating each respective semi-finished product quantity further comprises:
converting the resources consumed for manufacturing products related to a standard product into a capacity equivalent, wherein the conversion references a resource consumption quantity for manufacturing the standard product;
determining whether each respective semi-finished product can be produced in each of the front-end TFT-LCD manufacturing factories, wherein the determination is made according to a manufacturing feasibility parameter; and
calculating a glass substrate cutting loss area of each respective semi-finished product at each of the front-end TFT-LCD manufacturing factories, wherein the calculation is performed according to a glass substrate cutting loss rate.

9. The method for planning global logistics as claimed in claim 7, wherein after calculating the shipping quantity, the method further comprises:
calculating an inventory quantity o, wherein the calculation is performed according to the semi-finished product quantity and the shipping quantity.

10. The method for planning global logistics as claimed in claim 9, wherein calculating the inventory quantity further comprises:
limiting the inventory quantity according to a storage quantity.

11. The method for planning a global logistics system as claimed in claim 7, the method further comprising:
limiting a production quantity according to available capacity of each of the back-end LCM factories.

12. The method for planning global logistics as claimed in claim 7, wherein the performance index comprises one of a minimized total cost, a minimized glass substrate cutting loss area, and maximized production quantity, or a combination thereof.
